(19) United States
(12) Patent Application Publication
(10) Pub. No.: US 2026/0360126 A1
(43) Pub. Date: Nov. 12, 2026

(54) MACHINE LEARNING MODEL TRAINING FOR OBSTRUCTED VEHICLE SENSOR DETECTION

(71) Applicant: GM Global Technology Operations LLC, Detroit, MI (US)

(72) Inventor: Asif Zamir, Tel Aviv (IL)

(21) Appl. No.: 19/204,981

(22) Filed: May 12, 2025

(51) Int. Cl. G06V 10/774; G06V 10/98; G06V 20/56

(52) U.S. Cl. CPC G06V 10/774; G06V 10/993; G06V 20/56

(57) ABSTRACT

A method for training a camera obstruction detection machine learning model may include training a first machine learning model using a first training dataset. The first machine learning model is configured to generate artificially obstructed images. The method further may include generating a second training dataset of artificially obstructed images using the first machine learning model and a third training dataset. The method further may include training the camera obstruction detection machine learning model using the second training dataset. The camera obstruction detection machine learning model is configured to distinguish between obstructed and unobstructed images.

### INTRODUCTION

The present disclosure relates to systems and methods for machine learning model training for vehicle applications.

To enable dynamic and adaptable functions in vehicles, machine learning models may be utilized to process sensor data and support tasks such as object detection, vehicle localization, driver behavior prediction, path planning, and more. Machine learning models may be trained using supervised, unsupervised, or reinforcement learning algorithms. In some examples, sensor datasets may include visual data from cameras, ranging data from light detection and ranging (LIDAR) or radar sensors, or time-series signals from vehicle control systems. Model architectures may include convolutional neural networks, recurrent neural networks, transformer-based models, and/or the like. In some examples, training is performed using high-performance computing systems and large labeled datasets collected from fleet operations. In some examples, continual learning strategies are employed to update models post-deployment to maintain performance in changing real-world conditions.

While systems and methods for machine learning model training for vehicle applications achieve their intended purpose, there is a need for new and improved systems and methods for training machine learning models for use in vehicles.

### SUMMARY

According to several aspects, a method for training a camera obstruction detection machine learning model is provided. The method may include training a first machine learning model using a first training dataset. The first machine learning model is configured to generate artificially obstructed images. The method further may include generating a second training dataset of artificially obstructed images using the first machine learning model and a third training dataset. The method further may include training the camera obstruction detection machine learning model using the second training dataset. The camera obstruction detection machine learning model is configured to distinguish between obstructed and unobstructed images.

In another aspect of the present disclosure, training the first machine learning model further may include capturing the first training dataset. The first training dataset includes a plurality of naturally obstructed images. Training the first machine learning model further may include identifying an obstructed region of each of the plurality of naturally obstructed images. Training the first machine learning model further may include training the first machine learning model based at least in part on the plurality of naturally obstructed images and the obstructed region of each of the plurality of naturally obstructed images.

In another aspect of the present disclosure, training the first machine learning model further may include generating a plurality of input training images by filling the obstructed region of each of the plurality of naturally obstructed images with noise. Training the first machine learning model further may include training the first machine learning model using the plurality of input training images as input and the plurality of naturally obstructed images as ground truth.

In another aspect of the present disclosure, training the first machine learning model further may include training the first machine learning model. The first machine learning model is configured to iteratively replace the noise with an artificially generated obstruction.

In another aspect of the present disclosure, generating the second training dataset further may include capturing the third training dataset. The third training dataset includes a plurality of unobstructed images. Generating the second training dataset further may include generating the second training dataset using the first machine learning model based at least in part on the third training dataset. The second training dataset includes a plurality of artificially obstructed images.

In another aspect of the present disclosure, generating the plurality of artificially obstructed images further may include generating an artificially generated obstruction on each of the plurality of unobstructed images using the first machine learning model.

In another aspect of the present disclosure, generating the artificially generated obstruction on each of the plurality of unobstructed images further may include defining an artificial obstructed region in each of the plurality of unobstructed images. Generating the artificially generated obstruction on each of the plurality of unobstructed images further may include filling the artificial obstructed region in each of the plurality of unobstructed images with noise. Generating the artificially generated obstruction on each of the plurality of unobstructed images further may include replacing the noise in each of the plurality of unobstructed images with the artificially generated obstruction by recursively executing the first machine learning model.

In another aspect of the present disclosure, defining the artificial obstructed region in each of the plurality of unobstructed images further may include training a second machine learning model to generate image masks defining artificial obstructed regions. Defining the artificial obstructed region in each of the plurality of unobstructed images further may include generating a plurality of image masks using the second machine learning model. Defining the artificial obstructed region in each of the plurality of unobstructed images further may include applying one or more of the plurality of image masks to each of the plurality of unobstructed images to define the artificial obstructed region in each of the plurality of unobstructed images.

In another aspect of the present disclosure, training the second machine learning model further may include training the second machine learning model using a shape of an obstructed region of each naturally obstructed training image in the first training dataset as ground truth.

In another aspect of the present disclosure, training the camera obstruction detection machine learning model further may include generating a fourth training dataset. The fourth training dataset includes the second training dataset labeled as obstructed and the third training dataset labeled as unobstructed. Training the camera obstruction detection machine learning model further may include training the camera obstruction detection machine learning model using the fourth training dataset.

According to several aspects, a system for training a camera obstruction detection machine learning model for a vehicle, the system may include a camera and a controller in electrical communication with the camera. The controller is programmed to capture a first training dataset using the camera. The first training dataset includes a plurality of naturally obstructed images. The controller is further programmed to identify an obstructed region of each of the plurality of naturally obstructed images. The controller is further programmed to train a first machine learning model based at least in part on the plurality of naturally obstructed images and the obstructed region of each of the plurality of naturally obstructed images. The first machine learning model is configured to generate artificially obstructed images. The controller is further programmed to generate a second training dataset of artificially obstructed images using the first machine learning model and a third training dataset. The controller is further programmed to train the camera obstruction detection machine learning model using the second training dataset. The camera obstruction detection machine learning model is configured to distinguish between obstructed and unobstructed images.

In another aspect of the present disclosure, to train the first machine learning model, the controller is further programmed to generate a plurality of input training images by filling the obstructed region of each of the plurality of naturally obstructed images with noise. To train the first machine learning model, the controller is further programmed to train the first machine learning model using the plurality of input training images as input and the plurality of naturally obstructed images as ground truth. The first machine learning model is configured to iteratively replace the noise with an artificially generated obstruction.

In another aspect of the present disclosure, to generate the second training dataset further may include, the controller is further programmed to capture the third training dataset using the camera. The third training dataset includes a plurality of unobstructed images. To generate the second training dataset further may include, the controller is further programmed to generate the second training dataset using the first machine learning model based at least in part on the third training dataset. The second training dataset includes a plurality of artificially obstructed images.

In another aspect of the present disclosure, to generate the plurality of artificially obstructed images, the controller is further programmed to generate an artificially generated obstruction on each of the plurality of unobstructed images using the first machine learning model.

In another aspect of the present disclosure, to generate the artificially generated obstruction on each of the plurality of unobstructed images, the controller is further programmed to define an artificial obstructed region in each of the plurality of unobstructed images. To generate the artificially generated obstruction on each of the plurality of unobstructed images, the controller is further programmed to fill the artificial obstructed region in each of the plurality of unobstructed images with noise. To generate the artificially generated obstruction on each of the plurality of unobstructed images, the controller is further programmed to replace the noise in each of the plurality of unobstructed images with the artificially generated obstruction by recursively executing the first machine learning model.

In another aspect of the present disclosure, to define the artificial obstructed region in each of the plurality of unobstructed images, the controller is further programmed to train a second machine learning model using a shape of the obstructed region of each naturally obstructed training image in the first training dataset as ground truth. The second machine learning model is configured to generate image masks defining artificial obstructed regions. To define the artificial obstructed region in each of the plurality of unobstructed images, the controller is further programmed to generate a plurality of image masks using the second machine learning model. To define the artificial obstructed region in each of the plurality of unobstructed images, the controller is further programmed to apply one or more of the plurality of image masks to each of the plurality of unobstructed images to define the artificial obstructed region in each of the plurality of unobstructed images.

In another aspect of the present disclosure, to train the camera obstruction detection machine learning model, the controller is further programmed to generate a fourth training dataset. The fourth training dataset includes the second training dataset labeled as obstructed and the third training dataset labeled as unobstructed. To train the camera obstruction detection machine learning model, the controller is further programmed to train the camera obstruction detection machine learning model using the fourth training dataset.

According to several aspects, a method for training a camera obstruction detection machine learning model for a vehicle is provided. The method may include capturing a first training dataset using a camera. The first training dataset includes a plurality of naturally obstructed images. The method further may include identifying an obstructed region of each of the plurality of naturally obstructed images. The method further may include training a first machine learning model based at least in part on the plurality of naturally obstructed images and the obstructed region of each of the plurality of naturally obstructed images. The first machine learning model is configured to generate artificially obstructed images. The method further may include generating a second training dataset of artificially obstructed images. Generating the second training dataset further may include capturing a third training dataset. The third training dataset includes a plurality of unobstructed images. The method further may include generating the second training dataset using the first machine learning model based at least in part on the third training dataset. The second training dataset includes a plurality of artificially obstructed images. The method further may include generating a fourth training dataset. The fourth training dataset includes the second training dataset labeled as obstructed and the third training dataset labeled as unobstructed. The method further may include training the camera obstruction detection machine learning model using the fourth training dataset. The camera obstruction detection machine learning model is configured to distinguish between obstructed and unobstructed images.

In another aspect of the present disclosure, generating the second training dataset further may include defining an artificial obstructed region in each of the plurality of unobstructed images. Generating the second training dataset further may include filling the artificial obstructed region in each of the plurality of unobstructed images with noise. Generating the second training dataset further may include replacing the noise in each of the plurality of unobstructed images with an artificially generated obstruction by recursively executing the first machine learning model.

In another aspect of the present disclosure, defining the artificial obstructed region in each of the plurality of unobstructed images further may include training a second machine learning model using a shape of an obstructed region of each naturally obstructed training image in the first training dataset as ground truth. The second machine learning model is configured to generate image masks defining artificial obstructed regions. Defining the artificial obstructed region in each of the plurality of unobstructed images further may include generating a plurality of image masks using the second machine learning model. Defining the artificial obstructed region in each of the plurality of unobstructed images further may include applying one or more of the plurality of image masks to each of the plurality of unobstructed images to define the artificial obstructed region in each of the plurality of unobstructed images.

Further areas of applicability will become apparent from the description provided herein. It should be understood that the description and specific examples are intended for purposes of diagram only and are not intended to limit the scope of the present disclosure.

### BRIEF DESCRIPTION OF THE DRAWINGS

The drawings described herein are for diagram purposes only and are not intended to limit the scope of the present disclosure in any way.

FIG. 1 is a schematic diagram of a system for training a camera obstruction detection machine learning model for a vehicle, according to an exemplary embodiment;

FIG. 2 is a flowchart of a method for training a camera obstruction detection machine learning model for a vehicle, according to an exemplary embodiment;

FIG. 3 is a diagram for explanation of a first portion of the method for training a camera obstruction detection machine learning model for a vehicle, according to an exemplary embodiment; and

FIG. 4 is a diagram for explanation of a second portion of the method for training a camera obstruction detection machine learning model for a vehicle, according to an exemplary embodiment.

### DETAILED DESCRIPTION

The following description is merely exemplary in nature and is not intended to limit the present disclosure, application, or uses.

In aspects of the present disclosure, it is advantageous to determine when cameras of a vehicle are obstructed by foreign objects such as dirt, mud, sand, snow, water, and/or the like. In aspects of the present disclosure, a camera obstruction detection machine learning model can be used to determine whether cameras of a vehicle are obstructed by foreign objects. However, in aspects of the present disclosure, training the camera obstruction detection machine learning model presents a technical problem because of the need for large volumes of examples of obstructed camera images for training. The present disclosure provides a new and improved system and method for training a camera obstruction detection machine learning model for a vehicle which provides an improvement to the technological process of training the camera obstruction detection machine learning model, resulting in increased efficiency and effectiveness.

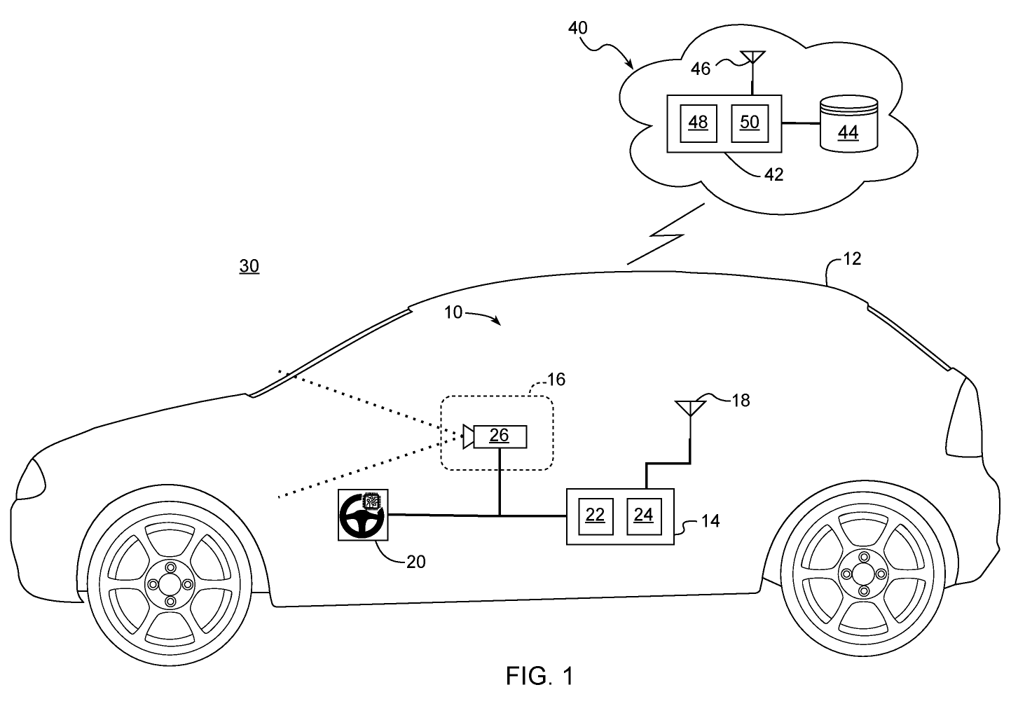

Referring to FIG. 1, a system for training a camera obstruction detection machine learning model for a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, one or more sensors 16, a vehicle communication system 18 and an automated driving system 20.

The controller 14 is used to implement a method 100 for training a camera obstruction detection machine learning model for a vehicle, as will be described below. The controller 14 includes at least one processor 22 and a non-transitory computer readable storage device or media 24. The processor 22 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 24 may include volatile and nonvolatile storage in read-only memory (ROM), random-access memory (RAM), and keep-alive memory (KAM), for example. KAM is a persistent or non-volatile memory that may be used to store various operating variables while the processor 22 is powered down. The computer-readable storage device or media 24 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also include multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the one or more sensors 16, the vehicle communication system 18, and the automated driving system 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The one or more sensors 16 are used to acquire information relevant to the vehicle 12. In an exemplary embodiment, at least one of the one or more sensors 16 includes a camera 26. It should be understood that the one or more sensors 16 may include additional and/or alternate sensors without departing from the scope of the present disclosure.

In another exemplary embodiment, the one or more sensors 16 further include sensors to determine performance data about the vehicle 12. In a non-limiting example, the one or more sensors 16 further include at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In another exemplary embodiment, the one or more sensors 16 further include sensors to determine information about an environment within the vehicle 12. In a non-limiting example, the one or more sensors 16 further include at least one of a seat occupancy sensor, a cabin air temperature sensor, a cabin motion detection sensor, a cabin camera, a cabin microphone, and/or the like.

In another exemplary embodiment, the one or more sensors 16 further include sensors to determine information about an environment 30 surrounding the vehicle 12. In a non-limiting example, the one or more sensors 16 further include at least one of an ambient air temperature sensor, a barometric pressure sensor, a global navigation satellite system (GNSS), and/or a photo and/or video camera which is positioned to view the environment 30 in front of the vehicle 12.

In another exemplary embodiment, at least one of the one or more sensors 16 is a perception sensor capable of perceiving objects and/or measuring distances in the environment 30 surrounding the vehicle 12. In a non-limiting example, the one or more sensors 16 includes a stereoscopic camera having distance measurement capabilities. In one example, at least one of the one or more sensors 16 is affixed inside of the vehicle 12, for example, in a headliner of the vehicle 12, having a view through a windscreen of the vehicle 12. In another example, at least one of the one or more sensors 16 is affixed outside of the vehicle 12, for example, on a roof of the vehicle 12, having a view of the environment 30 surrounding the vehicle 12. It should be understood that various additional types of perception sensors, such as, for example, light detection and ranging (LIDAR) sensors, ultrasonic ranging sensors, radar sensors, and/or time-of-flight sensors are within the scope of the present disclosure. The one or more sensors 16 are in electrical communication with the controller 14 as discussed above.

The camera 26 is a perception sensor used to capture images and/or videos of the environment 30 surrounding the vehicle 12. In an exemplary embodiment, the camera 26 includes a photo and/or video camera which is positioned to view the environment 30 surrounding the vehicle 12. In a non-limiting example, the camera 26 includes a camera affixed inside of the vehicle 12, for example, in a headliner of the vehicle 12, having a view through the windscreen. In another non-limiting example, the camera 26 includes a camera affixed outside of the vehicle 12, for example, on a roof of the vehicle 12, having a view of the environment 30 in front of the vehicle 12.

In another exemplary embodiment, the camera 26 refers to a surround view camera system including a plurality of cameras arranged to provide a view of the environment 30 adjacent to two or more sides of the vehicle 12. In a non-limiting example, the camera 26 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera 26 further includes an additional rear-view camera mounted near a center high mounted stop lamp of the vehicle 12. Accordingly, the camera 26 is configured to capture images showing an environment in front of the vehicle 12, images showing an environment behind the vehicle 12, images showing an environment left of the vehicle 12, and/or images showing an environment right of the vehicle 12. In a non-limiting example, the two side-facing cameras include both front and rear facing side cameras, allowing the camera 26 to capture a front- and rear-ward view on each side of the vehicle 12.

It should be understood that camera systems having additional cameras and/or additional mounting locations are within the scope of the present disclosure. It should be understood that the system 10 and method 100 of the present disclosure may also be used with fewer cameras, but more cameras will provide a more complete view of the environment 30. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The vehicle communication system 18 is used by the controller 14 to communicate with other systems external to the vehicle 12. For example, the vehicle communication system 18 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 18 is a wireless communication system configured to communicate via a wireless local area network (WLAN) using IEEE 802.11 standards or by using cellular data communication (e.g., using GSMA standards, such as, for example, SGP.02, SGP.24, SGP.32, and the like). Accordingly, the vehicle communication system 18 may further include an embedded universal integrated circuit card (eUICC) configured to store at least one cellular connectivity configuration profile, for example, an embedded subscriber identity module (eSIM) profile.

The vehicle communication system 18 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 18 may include one or more antennas and/or communication transceivers for receiving and/or transmitting signals, such as cooperative sensing messages (CSMs). The vehicle communication system 18 is configured to wirelessly communicate information between the vehicle 12 and another vehicle. Further, the vehicle communication system 18 is configured to wirelessly communicate information between the vehicle 12 and infrastructure or other vehicles. It should be understood that the vehicle communication system 18 may be integrated with the controller 14 (e.g., on a same circuit board with the controller 14 or otherwise a part of the controller 14) without departing from the scope of the present disclosure.

The automated driving system 20 is used to provide assistance to the occupant to increase occupant awareness and/or control behavior of the vehicle 12. In the scope of the present disclosure, the automated driving system 20 encompasses systems which provide any level of assistance to the occupant (e.g., blind spot warning, lane departure warning, and/or the like) and systems which are capable of autonomously driving the vehicle 12 under some or all conditions (e.g., automated lane keeping, adaptive cruise control, fully autonomous driving, and/or the like). It should be understood that all levels of driving automation defined by, for example, SAE J3016 (i.e., SAE LEVEL 0, SAE LEVEL 1, SAE LEVEL 2, SAE LEVEL 3, SAE LEVEL 4, and SAE LEVEL 5) are within the scope of the present disclosure.

In an exemplary embodiment, the automated driving system 20 is configured to detect and/or receive information about the environment 30 surrounding the vehicle 12 and process the information to provide assistance to the occupant. In some embodiments, the automated driving system 20 includes a software module executed on the controller 14. In other embodiments, the automated driving system 20 includes a separate automated driving system controller, similar to the controller 14, capable of processing the information about the environment 30 surrounding the vehicle 12. In an exemplary embodiment, the automated driving system 20 may operate in a manual operation mode, a partially automated operation mode, and a fully automated operation mode.

In the scope of the present disclosure, the manual operation mode means that the automated driving system 20 provides warnings or notifications to the occupant but does not intervene or control the vehicle 12 directly. In a non-limiting example, the automated driving system 20 receives information from the one or more sensors 16. Using techniques such as, for example, computer vision, the automated driving system 20 understands the environment 30 surrounding the vehicle 12 and provides assistance to the occupant. For example, if the automated driving system 20 identifies, based on data from the one or more sensors 16, that the vehicle 12 is likely to collide with a remote vehicle, the automated driving system 20 may use a display to provide a warning to the occupant.

In the scope of the present disclosure, the partially automated operation mode means that the automated driving system 20 provides warnings or notifications to the occupant and may intervene or control the vehicle 12 directly in certain situations. In a non-limiting example, the automated driving system 20 is additionally in electrical communication with components of the vehicle 12 such as a brake system, a propulsion system, and/or a steering system of the vehicle 12, such that the automated driving system 20 may control the behavior of the vehicle 12. In a non-limiting example, the automated driving system 20 may control the behavior of the vehicle 12 by applying brakes of the vehicle 12 to avoid an imminent collision. In another non-limiting example, the automated driving system 20 may control the steering system of the vehicle 12 to provide an automated lane keeping feature. In another non-limiting example, the automated driving system 20 may control the brake system, propulsion system, and steering system of the vehicle 12 to temporarily drive the vehicle 12 towards a predetermined destination. However, intervention by the occupant may be required at any time. In an exemplary embodiment, the automated driving system 20 may include additional components such as, for example, an eye tracking device configured to monitor an attention level of the occupant and ensure that the occupant is prepared to take over control of the vehicle 12.

In the scope of the present disclosure, the fully automated operation mode means that the automated driving system 20 uses data from the one or more sensors 16 to understand the environment 30 and control the vehicle 12 to drive the vehicle 12 to a predetermined destination without a need for control or intervention by the occupant.

The automated driving system 20 operates using a path planning algorithm which is configured to generate a safe and efficient trajectory for the vehicle 12 to navigate in the environment surrounding the vehicle 12. In an exemplary embodiment, the path planning algorithm is a machine learning algorithm trained to output control signals for the vehicle 12 based on input data collected from the one or more sensors 16. In another exemplary embodiment, the path planning algorithm is a deterministic algorithm which has been programmed to output control signals for the vehicle 12 based on data collected from the one or more sensors 16.

In a non-limiting example, the path planning algorithm generates a sequence of waypoints or a continuous path that the vehicle 12 should follow to reach a destination while adhering to rules, regulations, and safety constraints. The sequence of waypoints or continuous path is generated based at least in part on a detailed map and a current state of the vehicle 12 (i.e., position, velocity, and orientation of the vehicle 12). The detailed map includes, for example, information about lane boundaries, road geometry, speed limits, traffic signs, and/or other relevant features. In an exemplary embodiment, the detailed map is stored in the media 24 of the controller 14 and/or on a remote database or server. In another exemplary embodiment, the path planning algorithm performs perception and mapping tasks to interpret data collected from the one or more sensors 16 and create, update, and/or augment the detailed map.

It should be understood that the automated driving system 20 may include any software and/or hardware module configured to operate in the manual operation mode, the partially automated operation mode, or the fully automated operation mode as described above.

With continued reference to FIG. 1, a remote server system is illustrated and generally indicated by reference number 40. The remote server system 40 includes a server controller 42 in electrical communication with a server database 44 and a server communication system 46. In a non-limiting example, the remote server system 40 is located in a server farm, datacenter, or the like, and connected to the internet.

The server controller 42 includes at least one server processor 48 and a server non-transitory computer readable storage device or server media 50. The description of the type and configuration given above for the controller 14 also applies to the server controller 42. In some examples, the server controller 42 may differ from the controller 14 in that the server controller 42 is capable of a higher processing speed, includes more memory, includes more inputs/outputs, and/or the like. In a non-limiting example, the server controller 42 includes one or more graphics processing units (GPU) or other purpose-built processing units configured for training and/or execution of machine learning models. In a non-limiting example, the server processor 48 and server media 50 of the server controller 42 are similar in structure and/or function to the processor 22 and the media 24 of the controller 14, as described above.

The server database 44 is used to store data such as machine learning model training data, as will be discussed in greater detail below. In an exemplary embodiment, the server database 44 includes one or more mass storage devices, such as, for example, hard disk drives, magnetic tape drives, magneto-optical disk drives, optical disks, solid-state drives, and/or additional devices operable to store data in a persisting and machine-readable fashion. In some examples, the one or more mass storage devices may be configured to provide redundancy in case of hardware failure and/or data corruption, using, for example, a redundant array of independent disks (RAID). In a non-limiting example, the server controller 42 may execute software such as, for example, a database management system (DBMS), allowing data stored on the one or more mass storage devices to be organized and accessed.

The server communication system 46 is used to communicate with external systems, such as, for example, the controller 14 via the vehicle communication system 18. In a non-limiting example, the server communication system 46 is similar in structure and/or function to the vehicle communication system 18, as described above. In some examples, the server communication system 46 may differ from the vehicle communication system 18 in that the server communication system 46 is capable of higher power signal transmission, more sensitive signal reception, higher bandwidth transmission, additional transmission/reception protocols, and/or the like.

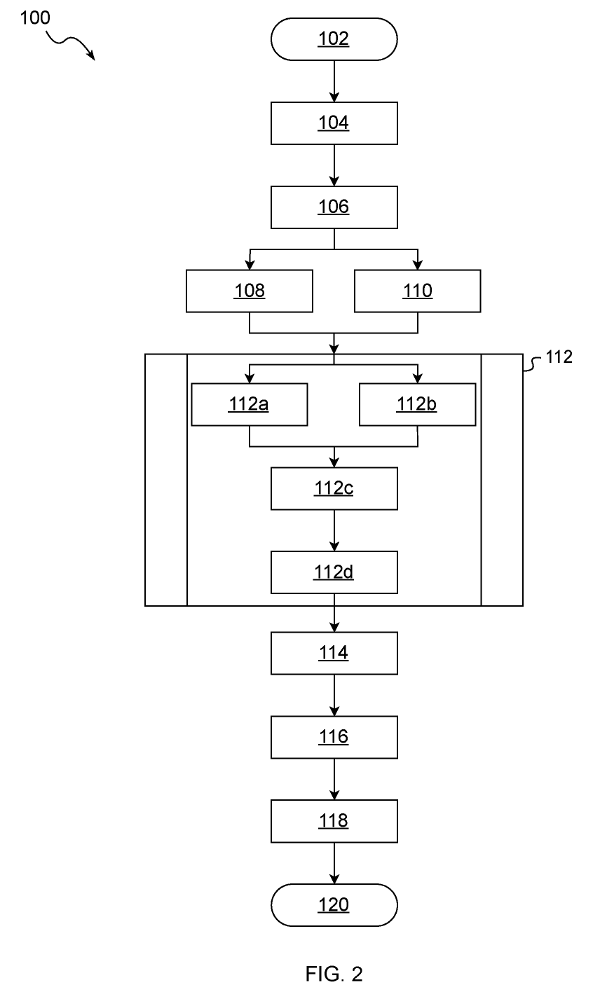

Referring to FIG. 2, a flowchart of the method 100 for training a camera obstruction detection machine learning model for a vehicle is shown. It should be understood that the method 100 may be executed in whole or in part by either the system 10 and/or the remote server system 40. In some embodiments, some portions of the method 100 (e.g., portions including capturing image data) may be executed using the system 10. Some portions of the method 100 (e.g., portions including training of machine learning models) may be executed using the remote server system 40. Data may be transferred between the system 10 and the remote server system 40 using the vehicle communication system 18 and the server communication system 46. In other embodiments, the method 100 is executed entirely using the system 10 or the remote server system 40. Therefore, the following disclosure and explanation of the method 100 is applicable at least for use with the system 10, the remote server system 40, and any combination thereof.

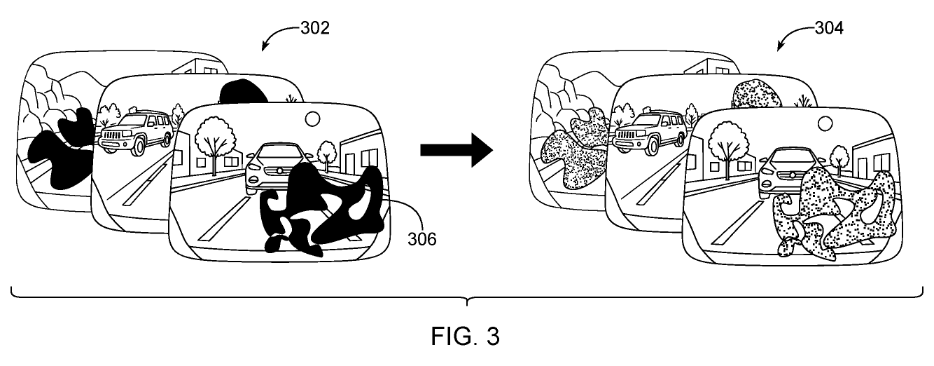

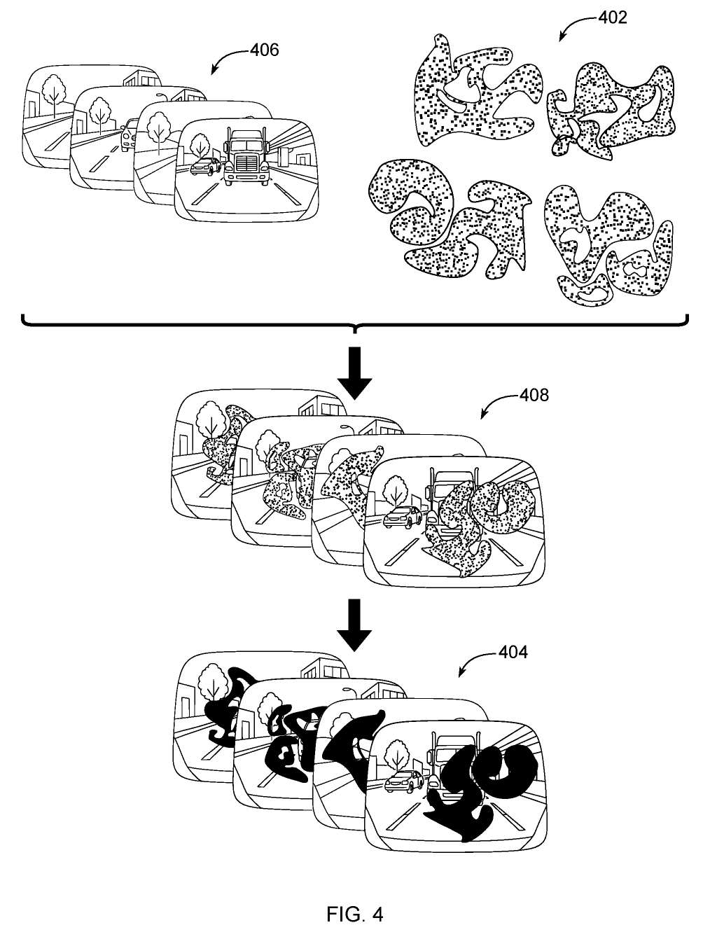

Referring to FIG. 3 a diagram for explanation of a first portion of the method 100 is shown. Referring to FIG. 4, a diagram for explanation of a second portion of the method 100 is shown. With reference to FIGS. 2-4, the method 100 begins at block 102 and proceeds to block 104. At block 104, the controller 14 captures a first training dataset 302 (FIG. 3) using the camera 26. In an exemplary embodiment, the first training dataset 302 includes a plurality of naturally obstructed images. In the scope of the present disclosure, an obstructed image is an image which is partially or fully covered or obstructed by one or more foreign objects or an environmental condition.

In the scope of the present disclosure, a naturally obstructed image is an image which is captured when the camera 26 has become obstructed during normal operation of the vehicle 12, for example, due to adhesion of dirt, dust, mud, snow, ice, water, or the like to the camera 26. In a non-limiting example, the plurality of naturally obstructed images includes images captured in various environmental conditions, lighting conditions, and weather conditions. The plurality of naturally obstructed images further includes images with various types, colors, sizes, positions, and degrees of obstruction. In a non-limiting example, the first training dataset 302 is crowdsourced from multiple vehicles. In an exemplary embodiment, the first training dataset 302 is transferred to the remote server system 40 using the vehicle communication system 18. After block 104, the method 100 proceeds to block 106.

At block 106, the server controller 42 receives the first training dataset 302 using the server communication system 46 and generates a plurality of input training images 304 (FIG. 3). In an exemplary embodiment, to generate the plurality of input training images 304, the server controller 42 identifies an obstructed region 306 (FIG. 3) of each of the plurality of naturally obstructed images in the first training dataset 302. In the scope of the present disclosure, the obstructed region 306 is a portion of the image which is covered or obstructed by a foreign object. In a non-limiting example, the obstructed region 306 is identified using a computer vision algorithm such as, for example, an image segmentation algorithm. In another non-limiting example, the obstructed region 306 is identified by a human data annotator who marks a boundary of the obstructed region 306. After identifying the obstructed region 306, the obstructed region 306 is filled with noise (e.g., Gaussian noise) to generate the plurality of input training images 304. After block 106, the method 100 proceeds to blocks 108 and 110.

At block 108, the server controller 42 trains a first machine learning model. In the scope of the present disclosure, a machine learning model is a computational construct including one or more algorithms, mathematical functions, and/or data structures that are trained using input data to identify patterns, relationships, or statistical structures. The model includes a set of learned parameters, weights, or internal representations that enable it to generate output, such as predictions, classifications, rankings, decisions, or synthesized content when presented with new input data. In the scope of the present disclosure, training a machine learning model means executing a computational process by which the model's internal parameters, weights, or representations are iteratively adjusted based on a set of input data and corresponding target outputs, such that the model learns to approximate a desired function, predict outcomes, classify inputs, or generate data consistent with the underlying statistical properties of the training data.

In an exemplary embodiment, the first machine learning model is configured to generate artificially obstructed images. In the scope of the present disclosure, an artificially obstructed image is an image having a computer-generated obstruction. To train the first machine learning model, the plurality of input training images 304 generated at block 106 are used as input and the plurality of naturally obstructed images of the first training dataset 302 are used as ground truth. In the scope of the present disclosure, ground truth refers to a target output that represents a correct or intended result against which a model’s predictions are compared and evaluated during training.

In an exemplary embodiment, during training, the first machine learning model is configured to learn a transformation function that maps features of the unobstructed image to features present in the naturally obstructed image, thereby capturing the statistical and structural characteristics of natural obstructions as observed in the first training dataset 302. In a non-limiting example, the training process involves minimizing a loss function that quantifies the discrepancy between the model-generated (artificially obstructed) image and the naturally obstructed ground truth image. As training progresses, the first machine learning model learns to synthesize output images that emulate the obstructions present in real-world scenarios, conditioned on the unobstructed input.

In a non-limiting example, the first machine learning model is realized using a diffusion denoising probabilistic model (DDPM). In the scope of the present disclosure a DDPM is a machine learning model that that learns to remove noise step-by-step, reconstructing data from pure noise. In a non-limiting example, the first machine learning model is trained to iteratively denoise an image at each timestep, conditioned on the image context and the current noisy sample. During training, one of the plurality of input training images 304 is provided as the conditioning input, and the first machine learning model learns to denoise progressively such that the final output closely resembles a corresponding one of the plurality of naturally obstructed images of the first training dataset 302.

Upon completion of training, the first machine learning model can be used to sample a noise vector in an image and iteratively denoise it under the guidance of the surrounding context of the image, thereby generating an artificially obstructed image that emulates the statistical properties of naturally occurring obstructions. It should be understood that the above explanation of the training process is merely exemplary in nature, and that other training processes and use of various types of machine learning models (e.g., generative adversarial networks, transformer-based generative models, diffusion probabilistic models, and/or the like) are within the scope of the present disclosure. After block 108, the method 100 proceeds to block 112.

At block 110, the server controller 42 trains a second machine learning model. The second machine learning model is trained to generate image masks 402 (FIG. 4) defining artificial obstructed regions. In the scope of the present disclosure, an image mask defining an artificial obstructed region is a computer-generated shape having a form which closely resembles the form and shape of natural obstructions. In a non-limiting example, the second machine learning model is trained using a shape of the obstructed region 306 of each naturally obstructed training image in the first training dataset 302 as ground truth. In an exemplary embodiment, during training, the second machine learning model is configured to learn a transformation function that captures the spatial and structural characteristics of the obstruction region 306 of each of the plurality of naturally obstructed images in the first training dataset 302.

In a non-limiting example, the training process involves minimizing a loss function that quantifies the discrepancy between the model-generated image mask and a ground truth mask representing the shape of the obstruction region 306 in one of the plurality of naturally obstructed images in the first training dataset 302. As training progresses, the second machine learning model learns to produce image masks having realistic shapes, sizes, and forms. It should be understood that the above explanation of the training process is merely exemplary in nature, and that other training processes and use of various types of machine learning models (e.g., generative adversarial networks, transformer-based generative models, diffusion denoising probabilistic models, and/or the like) are within the scope of the present disclosure. After block 110, the method 100 proceeds to block 112.

At block 112, a second training dataset 404 (FIG. 4) is generated. In an exemplary embodiment, the second training dataset 404 includes a plurality of artificially obstructed images. Block 112 includes blocks 112a, 112b, 112c, and 112d which are performed to generate the second training dataset 404. Block 112 begins with blocks 112a and 112b. At block 112a, the controller 14 captures a third training dataset 406 (FIG. 4) using the camera 26. In an exemplary embodiment, the third training dataset 406 includes a plurality of unobstructed images. In the scope of the present disclosure, an unobstructed image is an image which is not covered or obstructed by any foreign objects or any environmental condition.

In a non-limiting example, the plurality of unobstructed images includes images captured in various environmental conditions, lighting conditions, and weather conditions. In a non-limiting example, the third training dataset 406 is crowdsourced from multiple vehicles. In a non-limiting example, the third training dataset 406 includes a larger quantity of images than the first training dataset 302. It should be understood that the third training dataset 406 may be arbitrarily large. In an exemplary embodiment, the third training dataset 406 is transferred to the remote server system 40 using the vehicle communication system 18. After block 112a, the method 100 proceeds to block 112c.

At block 112b, the server controller 42 generates a plurality of image masks 402 using the second machine learning model trained at block 110. In an exemplary embodiment, the plurality of image masks 402 includes computer-generated image masks having various shapes, sizes, and angles of rotation resembling realistic obstructions. In an exemplary embodiment, the plurality of image masks 402 are filled with noise (e.g., Gaussian noise). After block 112b, the method 100 proceeds to block 112c.

At block 112c, the server controller 42 defines an artificial obstructed region in each of the plurality of unobstructed images of the third training dataset 406 by applying one of the plurality of image masks 402 generated at block 112b to each of the plurality of unobstructed images of the third training dataset 406. In the scope of the present disclosure, the artificial obstructed region is a portion of an image which is covered or obstructed by a computer-generated foreign object. Applying an image mask means overlaying the image mask on the unobstructed image. In a non-limiting example, the image mask is placed at a random or pseudo-random position and angle of rotation. The artificial obstructed region is filled with noise (e.g., Gaussian noise). The plurality of unobstructed images including artificial obstructed regions filled with noise is referred to as a plurality of noisy images 408. After block 112c, the method 100 proceeds to block 112d.

At block 112d, the server controller 42 iteratively replaces the noise in each of the plurality of noisy images 408 (i.e., the artificial obstructed region defined at block 112c) with an artificially generated obstruction. In the scope of the present disclosure, the artificially generated obstruction is a computer-generated foreign object which partially or fully obstructs an image. In an exemplary embodiment, to generate the artificially generated obstruction, the server controller 42 recursively executes the first machine learning model trained at block 108.

In a non-limiting example, the first machine learning model is configured to perform an iterative reverse diffusion process over a predefined number of denoising timesteps. At each timestep, the first machine learning model receives as input: (i) a current partially denoised image containing the artificial obstructed region, (ii) a timestep index, and (iii) an unobstructed context (i.e., the surrounding unmodified portions of the unobstructed image). Based on these inputs, the first machine learning model predicts the noise component at the given timestep, which is then subtracted from the noise in the artificial obstructed region, effectively updating the artificial obstructed region to a slightly more realistic representation of an obstruction.

The process is recursively repeated across successive timesteps, with each iteration refining the content within the artificial obstructed region while preserving consistency with the surrounding context of the unobstructed image. The model replaces the noise within the artificial obstructed region with learned obstruction-like features based on patterns observed during training on the plurality of naturally obstructed images of the first training dataset 302 at block 108. By the final timestep, the first machine learning model produces a fully denoised output wherein the noise in the artificial obstructed region has been replaced with a realistic, artificially generated obstruction integrated into the context of the unobstructed image. The process is repeated (e.g., in parallel) for each of the plurality of noisy images 408. It should be understood that the above explanation for the usage and operation of the first machine learning model is merely exemplary in nature. After block 112d, block 112 is concluded, and the method 100 proceeds to block 114.

At block 114, the server controller 42 generates a fourth training dataset. In an exemplary embodiment, the fourth training dataset is a concatenation the second training dataset 404 and the third training dataset 406. Elements from the second training dataset 404 are labeled as obstructed and elements from the third training dataset 406 are labeled as unobstructed. After block 114, the method 100 proceeds to block 116.

At block 116, the server controller 42 trains the camera obstruction detection machine learning model using the fourth training dataset generated at block 114. In the scope of the present disclosure, the camera obstruction detection machine learning model is a classifier model configured to distinguish between obstructed and unobstructed images. In an exemplary embodiment, the camera obstruction detection machine learning model is further configured to identify a type and/or location of obstructions in obstructed images.

In a non-limiting example, the camera obstruction detection machine learning model is trained using supervised learning based on the fourth training dataset. In a non-limiting example, the camera obstruction detection machine learning model is a convolutional neural network (CNN) which begins training with randomly assigned or pre-trained parameters. The camera obstruction detection machine learning model is exposed to the labeled fourth training dataset in iterative fashion, with each iteration referred to as an “epoch”. During each epoch, the camera obstruction detection machine learning model processes batches of input images and produces predicted classifications. A loss function is computed for each prediction to quantify the deviation from the ground truth label. An optimization algorithm, such as stochastic gradient descent or the like, is used to update the parameters of the camera obstruction detection machine learning model in a direction that minimizes the overall loss. The training process is repeated across multiple epochs until convergence criteria are satisfied.

Upon conclusion of training, the camera obstruction detection machine learning model is configured to discriminate between obstructed and unobstructed images when presented with previously unseen inputs. It should be understood that the above explanation of the training process is merely exemplary in nature, and that other training processes and use of various types of machine learning models (e.g., recurrent neural networks, transformer-based models, ensemble learning models, self-attention mechanisms, unsupervised feature extractors, and/or the like) are within the scope of the present disclosure. In an exemplary embodiment, after training the camera obstruction detection machine learning model, the camera obstruction detection machine learning model is transferred to the controller 14 of the vehicle 12 via the vehicle communication system 18. In an exemplary embodiment, after training the camera obstruction detection machine learning model, the camera obstruction detection machine learning model is transferred to a plurality of vehicles. After block 116, the method 100 proceeds to block 118.

At block 118, the system 10 uses the camera obstruction detection machine learning model to adjust an operation of the vehicle 12. In a non-limiting example, the camera obstruction detection machine learning model is used to pre-process images captured by the camera 26 before the images are provided to the automated driving system 20. For example, using the additional information provided by the camera obstruction detection machine learning model, the automated driving system 20 may ignore obstructed images to avoid false-positive detection of obstacles in the environment 30. By avoiding false-position detection of obstacles, the path taken by the vehicle 12 is adjusted.

In another example, using the additional information provided by the camera obstruction detection machine learning model, the automated driving system 20 adjust a route of the vehicle 12 to avoid areas of the environment 30 for which only an obstructed view is available. Therefore, the operation of the automated driving system 20, and thus the vehicle 12 is adjusted using the camera obstruction detection machine learning model. In another non-limiting example, the camera obstruction detection machine learning model is used to activate a camera cleaning system (e.g., a cleaning fluid sprayer, a mechanical wiper, and/or the like) in response to determining that images from the camera 26 are obstructed. It should be understood that various additional uses and applications for the camera obstruction detection machine learning model are within the scope of the present disclosure. After block 118, the method 100 proceeds to enter a standby state at block 120.

In an exemplary embodiment, the controller 14 repeatedly exits the standby state 120 and restarts the method 100 at block 102. In a non-limiting example, the controller 14 exits the standby state 120 and restarts the method 100 on a timer, for example, every three hundred milliseconds.

The system 10 and method 100 of the present disclosure offer several advantages. Effective training of the camera obstruction detection machine learning model could require tens of thousands of training images presented over hundreds of epochs (i.e., training iterations). Therefore, training the camera obstruction detection machine learning model presents a technical problem, especially because it could be resource intensive to capture a large enough training dataset due to the relative rarity of naturally obstructed camera conditions. The system 10 and method 100 present a particular technical solution which constitutes an improvement upon the technological process of training machine learning models and is integrated into the practical application of identification of obstructed cameras for the vehicle 12.

More particularly, using the system 10 and method 100, a relatively small initial training dataset (i.e., the first training dataset 302) is leveraged to generate a large training dataset (i.e., the fourth training dataset) to train the camera obstruction detection machine learning model. Therefore, the system 10 and method 100 provide improvements upon the technological process of training the camera obstruction detection machine learning model, resulting in a more effectively trained model while reducing resource expenditure required for training. After training, the camera obstruction detection machine learning model is used to adjust the operation of the vehicle 12 in various applications, such as automated driving applications as discussed above.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for training a camera obstruction detection machine learning model, the method comprising:
training a first machine learning model using a first training dataset, wherein the first machine learning model is configured to generate artificially obstructed images;
generating a second training dataset of artificially obstructed images using the first machine learning model and a third training dataset; and
training the camera obstruction detection machine learning model using the second training dataset, wherein the camera obstruction detection machine learning model is configured to distinguish between obstructed and unobstructed images.

2. The method of claim 1, wherein training the first machine learning model further comprises:
capturing the first training dataset, wherein the first training dataset includes a plurality of naturally obstructed images;
identifying an obstructed region of each of the plurality of naturally obstructed images; and
training the first machine learning model based at least in part on the plurality of naturally obstructed images and the obstructed region of each of the plurality of naturally obstructed images.

3. The method of claim 2, wherein training the first machine learning model further comprises:
generating a plurality of input training images by filling the obstructed region of each of the plurality of naturally obstructed images with noise; and
training the first machine learning model using the plurality of input training images as input and the plurality of naturally obstructed images as ground truth.

4. The method of claim 3, wherein training the first machine learning model further comprises:
training the first machine learning model, wherein the first machine learning model is configured to iteratively replace the noise with an artificially generated obstruction.

5. The method of claim 1, wherein generating the second training dataset further comprises:
capturing the third training dataset, wherein the third training dataset includes a plurality of unobstructed images; and
generating the second training dataset using the first machine learning model based at least in part on the third training dataset, wherein the second training dataset includes a plurality of artificially obstructed images.

6. The method of claim 5, wherein generating the plurality of artificially obstructed images further comprises:
generating an artificially generated obstruction on each of the plurality of unobstructed images using the first machine learning model.

7. The method of claim 6, wherein generating the artificially generated obstruction on each of the plurality of unobstructed images further comprises:
defining an artificial obstructed region in each of the plurality of unobstructed images;
filling the artificial obstructed region in each of the plurality of unobstructed images with noise; and
replacing the noise in each of the plurality of unobstructed images with the artificially generated obstruction by recursively executing the first machine learning model.

8. The method of claim 7, wherein defining the artificial obstructed region in each of the plurality of unobstructed images further comprises:
training a second machine learning model to generate image masks defining artificial obstructed regions;
generating a plurality of image masks using the second machine learning model; and
applying one or more of the plurality of image masks to each of the plurality of unobstructed images to define the artificial obstructed region in each of the plurality of unobstructed images.

9. The method of claim 8, wherein training the second machine learning model further comprises:
training the second machine learning model using a shape of an obstructed region of each naturally obstructed training image in the first training dataset as ground truth.

10. The method of claim 1, wherein training the camera obstruction detection machine learning model further comprises:
generating a fourth training dataset, wherein the fourth training dataset includes the second training dataset labeled as obstructed and the third training dataset labeled as unobstructed; and
training the camera obstruction detection machine learning model using the fourth training dataset.

11. A system for training a camera obstruction detection machine learning model for a vehicle, the system comprising:
a camera; and
a controller in electrical communication with the camera, wherein the controller is programmed to:
capture a first training dataset using the camera, wherein the first training dataset includes a plurality of naturally obstructed images;
identify an obstructed region of each of the plurality of naturally obstructed images;
train a first machine learning model based at least in part on the plurality of naturally obstructed images and the obstructed region of each of the plurality of naturally obstructed images, wherein the first machine learning model is configured to generate artificially obstructed images;
generate a second training dataset of artificially obstructed images using the first machine learning model and a third training dataset; and
train the camera obstruction detection machine learning model using the second training dataset, wherein the camera obstruction detection machine learning model is configured to distinguish between obstructed and unobstructed images.

12. The system of claim 11, wherein to train the first machine learning model, the controller is further programmed to:
generate a plurality of input training images by filling the obstructed region of each of the plurality of naturally obstructed images with noise; and
train the first machine learning model using the plurality of input training images as input and the plurality of naturally obstructed images as ground truth, wherein the first machine learning model is configured to iteratively replace the noise with an artificially generated obstruction.

13. The system of claim 12, wherein to generate the second training dataset further comprises, the controller is further programmed to:
capture the third training dataset using the camera, wherein the third training dataset includes a plurality of unobstructed images; and
generate the second training dataset using the first machine learning model based at least in part on the third training dataset, wherein the second training dataset includes a plurality of artificially obstructed images.

14. The system of claim 13, wherein to generate the plurality of artificially obstructed images, the controller is further programmed to:
generate an artificially generated obstruction on each of the plurality of unobstructed images using the first machine learning model.

15. The system of claim 14, wherein to generate the artificially generated obstruction on each of the plurality of unobstructed images, the controller is further programmed to:
define an artificial obstructed region in each of the plurality of unobstructed images;
fill the artificial obstructed region in each of the plurality of unobstructed images with noise; and
replace the noise in each of the plurality of unobstructed images with the artificially generated obstruction by recursively executing the first machine learning model.

16. The system of claim 15, wherein to define the artificial obstructed region in each of the plurality of unobstructed images, the controller is further programmed to:
train a second machine learning model using a shape of the obstructed region of each naturally obstructed training image in the first training dataset as ground truth, wherein the second machine learning model is configured to generate image masks defining artificial obstructed regions;
generate a plurality of image masks using the second machine learning model; and
apply one or more of the plurality of image masks to each of the plurality of unobstructed images to define the artificial obstructed region in each of the plurality of unobstructed images.

17. The system of claim 16, wherein to train the camera obstruction detection machine learning model, the controller is further programmed to:
generate a fourth training dataset, wherein the fourth training dataset includes the second training dataset labeled as obstructed and the third training dataset labeled as unobstructed; and
train the camera obstruction detection machine learning model using the fourth training dataset.

18. A method for training a camera obstruction detection machine learning model for a vehicle, the method comprising:
capturing a first training dataset using a camera, wherein the first training dataset includes a plurality of naturally obstructed images;
identifying an obstructed region of each of the plurality of naturally obstructed images;
training a first machine learning model based at least in part on the plurality of naturally obstructed images and the obstructed region of each of the plurality of naturally obstructed images, wherein the first machine learning model is configured to generate artificially obstructed images;
generating a second training dataset of artificially obstructed images, wherein generating the second training dataset further comprises:
capturing a third training dataset, wherein the third training dataset includes a plurality of unobstructed images; and
generating the second training dataset using the first machine learning model based at least in part on the third training dataset, wherein the second training dataset includes a plurality of artificially obstructed images;
generating a fourth training dataset, wherein the fourth training dataset includes the second training dataset labeled as obstructed and the third training dataset labeled as unobstructed; and
training the camera obstruction detection machine learning model using the fourth training dataset, wherein the camera obstruction detection machine learning model is configured to distinguish between obstructed and unobstructed images.

19. The method of claim 18, wherein generating the second training dataset further comprises:
defining an artificial obstructed region in each of the plurality of unobstructed images;
filling the artificial obstructed region in each of the plurality of unobstructed images with noise; and
replacing the noise in each of the plurality of unobstructed images with an artificially generated obstruction by recursively executing the first machine learning model.

20. The method of claim 19, wherein defining the artificial obstructed region in each of the plurality of unobstructed images further comprises:
training a second machine learning model using a shape of an obstructed region of each naturally obstructed training image in the first training dataset as ground truth, wherein the second machine learning model is configured to generate image masks defining artificial obstructed regions;
generating a plurality of image masks using the second machine learning model; and
applying one or more of the plurality of image masks to each of the plurality of unobstructed images to define the artificial obstructed region in each of the plurality of unobstructed images.
